(19) United States
(12) Patent Application Publication
(10) Pub. No.: US 2014/0089099 A1
(43) Pub. Date: Mar. 27, 2014

(54) INTERACTIVE SOCIAL MEDIA TICKER

(71) Applicant: OVERSTOCK.COM, INC., Salt Lake City, UT (US)

(72) Inventor: Ryan Money, Salt Lake City, UT (US)

(73) Assignee: OVERSTOCK.COM, INC., Salt Lake City, UT (US)

(21) Appl. No.: 13/626,682

(22) Filed: Sep. 25, 2012

(51) Int. Cl. G06F 3/0485

(52) U.S. Cl. CPC G06F 3/0485
USPC 705/14.66; 715/774; 705/14.73

(57) ABSTRACT

Systems, programs, non-transitory computer readable media, and methods of providing gift recommendations to a user of a social media website hosted by a social media server are described. For example, the user may grant an administrator server authorization to interface with the social media server such that the administrator server can identify important life events of the user's social media contacts, such as birthdays, anniversaries, weddings, and other events. If a social media contact of the user is determined to have an upcoming life event, then the administrator server generates a post containing (i) an advertisement that invites the user to review gift recommendations, and (ii) a link to a product page of an e-commerce website. Once generated, the post with the advertisement is streamed to a user device where it is displayed to the user in a ticker format along with other social media content.

### CROSS-REFERENCE TO RELATED APPLICATIONS

Not Applicable.

### STATEMENT REGARDING FEDERALLY SPONSORED RESEARCH OR DEVELOPMENT

Not Applicable.

### BACKGROUND

1. The Field of the Present Disclosure

The present disclosure relates generally to communication networks and social media websites, and more particularly, but not necessarily entirely, to systems, programs, and methods of generating product recommendations for users of social media websites.

2. Description of Related Art

Social media websites have increased in popularity in recent years. Popular social media websites include FACEBOOK, GOOGLE+, MYSPACE, LINKEDIN, FOURSQUARE, TWITTER, YOUTUBE, and others. Social media websites allow users at remote computers to browse and join networks. More sophisticated social media websites allow users to search for acquaintances and invite them to be contacts or friends.

To join a social media website, a user must first provide user account information, such as a login ID and a password. Each user is provided with his or her own user profile. A user profile provides a digital space, such as a compilation of individual webpages. The user can upload profile images and other images to his profile. The user profile further includes a contact section, which displays information regarding the user's contacts on the social media website. The contact section may allow the user to invite other users of the social media website to become contacts of the user. A contact is sometimes referred to in the social media context as a “friend” or “follower.” The user is able to access the user profiles of his contacts on the social media website.

The user profile may also include a private communication section that allows users to send private communications, including friend requests, between each other. The user profile may also provide a section that shows the personal information of the user. For example, the user profile information may indicate the gender of the user, the interests and hobbies of the user, the likes and dislikes of the user, the profession of the user, life events associated with the user, places of interest to the user, the relationship status of the user, the age of the user, the education of the user, and the religious views of the user.

A user profile may also include a comments section, sometimes referred to as a “wall” or “feed.” The comments section allows the user to receive and post social media content, including entries posted by other users, messages from other users, status updates associated with other users, photos uploaded by other users, news feeds, invitations to events, links to videos, as well as alerts and notifications generated automatically by the social media website.

In some instances, social media websites allow access to third parties. In particular, third-party applications running on remote computing devices interface with social media websites using an application programming interface (API). Prior to granting access to a third-party application, the social media websites may require authorization from a user of the social media website. These third-party applications can be web based, desk-top-computer based, or mobile-device based. Third-party applications interfacing with a social media website through an appropriate API may be able to retrieve information from user profiles and post messages.

One drawback to current social media websites is that users must typically log in to the websites to read or post comments. To address this problem, third-party applications have been developed to allow users to manage feeds from multiple social media websites. One such third-party application is TWEETDECK owned by TWITTER (www.tweetdeck.com). TWEETDECK allows users to aggregate feeds from TWITTER and FACEBOOK onto a single page. TWEETDECK further allows users to create columns of specific content that interests the users. TWEETDECK further allows users to filter social medial content. One drawback to TWEETDECK is that its users must still log in to access the content. Further, users are not provided with real-time updates while working on other applications. That is, users must still periodically check TWEETDECK to obtain the latest updates.

Another drawback to currently available third-party applications that aggregate social media content is that they provide limited advertising opportunities for e-commerce enterprises.

The prior art is thus characterized by several disadvantages that are addressed by the present disclosure. The present disclosure minimizes, and in some aspects eliminates, the above-mentioned failures, and other problems, by utilizing the methods and structural features described herein.

The features and advantages of the present disclosure will be set forth in the description that follows, and in part will be apparent from the description, or may be learned by the practice of the present disclosure without undue experimentation. The features and advantages of the present disclosure may be realized and obtained by means of the instruments and combinations particularly pointed out in the appended claims.

### BRIEF DESCRIPTION OF THE DRAWINGS

The features and advantages of the disclosure will become apparent from a consideration of the subsequent detailed description presented in connection with the accompanying drawings in which:

FIG. 1 is a schematic diagram of a system for providing a ticker-tape display of advertisements and social media content to a user according to an illustrative embodiment of the present invention;

FIG. 2 is a schematic diagram of a user display generated on a user device to allow the user to provide user account information for one or more social media websites to thereby authorize an administrator server program running on an administrator server to access those social media websites;

FIG. 3 is a schematic diagram of a user display generated on a user device that includes social media ticker bars positioned on a lower portion of the display area of the display according to an illustrative embodiment of the present disclosure;

FIG. 4 is a schematic diagram of a user display generated on a user device that includes social media ticker bars positioned on a lower portion of the display area of the display and a pop-up window that allows a user to post a comment in response to a post in one of the ticker bars according to an illustrative embodiment of the present disclosure;

FIG. 5 is a schematic diagram of a user display generated on a user device that includes social media ticker bars positioned on a lower portion of the display area of the display and a pop-up window that allows a user to select a link to a product recommendation page of an e-commerce website hosted by an e-commerce server according to an illustrative embodiment of the present disclosure;

FIG. 6 is a schematic diagram of a product recommendation page with product recommendations for a contact of a user on a social media website according to an illustrative embodiment of the present disclosure;

FIG. 7 is a schematic diagram of a user display generated on a user device that includes social media ticker bars positioned on a lower portion of the display area of the display and a pop-up window that includes product recommendations for a contact of a user on a social media website;

FIG. 8 is a schematic flow chart of a method of displaying an advertisement on a display of a user device according to an illustrative embodiment of the present disclosure; and

FIG. 9 is a schematic flow chart of a method of displaying an advertisement on a display of a user device according to an illustrative embodiment of the present disclosure.

### DETAILED DESCRIPTION

For the purposes of promoting an understanding of the principles in accordance with the disclosure, reference will now be made to the embodiments illustrated in the drawings and specific language will be used to describe them. It will nevertheless be understood that no limitation of the scope of the disclosure is thereby intended. Any alterations and further modifications of the inventive features illustrated herein, and any additional applications of the principles of the disclosure as illustrated herein, which would normally occur to one skilled in the relevant art and having possession of this disclosure, are to be considered within the scope of the disclosure claimed.

It must be noted that, as used in this specification and the appended claims, the singular forms “a,” “an,” and “the” include plural referents unless the context clearly dictates otherwise. In describing and claiming the present disclosure, the following terminology will be used in accordance with the definitions set out below. As used herein, the terms “comprising,” “including,” “containing,” “characterized by,” and grammatical equivalents thereof are inclusive or open-ended terms that do not exclude additional, unrecited elements or method steps.

Various embodiments of the present invention advantageously provide systems, devices, programs, non-transitory computer readable media, and methods for generating one or more social media ticker tapes on a display of a user device. For example, various embodiments of systems, systems, programs, non-transitory computer readable media, and methods may interface with social media websites to obtain social media content related to user accounts of a single user. The embodiments of systems, devices, programs, non-transitory computer readable media, and methods then stream the social media content to a user device such that the social media content is displayed in a tickertape format to the user.

The embodiments of systems, devices, programs, non-transitory computer readable media, and methods allow the user to position the ticker tapes at desired locations on the display of a user device. In addition, the user may be able to pause, rewind, hide, minimize, or maximize the ticker tapes. Embodiments of systems, devices, programs, non-transitory computer readable media, and methods allow a user to interact with social media content scrolling across the display of the user device in the ticker tapes. For example, a user may be able to comment on posts made by other users directly from the ticker tapes. That is, comments made by a user may be posted to the appropriate social media website. By way of another example, a user may be able to select links contained within social media content scrolling across the display of the user device in the ticker tape to thereby open the link destination in a web browser on the user device. Embodiments of systems, devices, programs, non-transitory computer readable media, and methods may allow a user to post updates to social media websites from the user device without directly logging into the social media websites.

Embodiments of systems, devices, programs, non-transitory computer readable media, and methods may request user profile information of contacts of a user on a social media website. Using the user profile information of a user's social media contacts, embodiments of systems, devices, programs, non-transitory computer readable media, and methods provide gift recommendations to the user. For example, if a contact of a user has an upcoming life event, such as a birthday, anniversary, or wedding, the present invention will identify the life event and then generate an advertisement that is displayed to the user in a social media ticker bar.

The advertisement may include a link to a product recommendation page associated with an e-commerce website. The product recommendation page displays products for sale that have been selected based on the information contained in the user profile of the contact. For example, if the contact with the upcoming life event has indicated in his or her profile that the contact enjoys hiking, then the product recommendation page will recommend products from an e-commerce website that are associated with hiking.

Embodiments of systems, devices, programs, non-transitory computer readable media, and methods include a product recommendation engine that is able to determine relevant products to recommend based on user profile information of social media contacts on a social media website. According to an embodiment, links to the product recommendations are provided to a user of a user device in a social media ticker on a display of the user device.

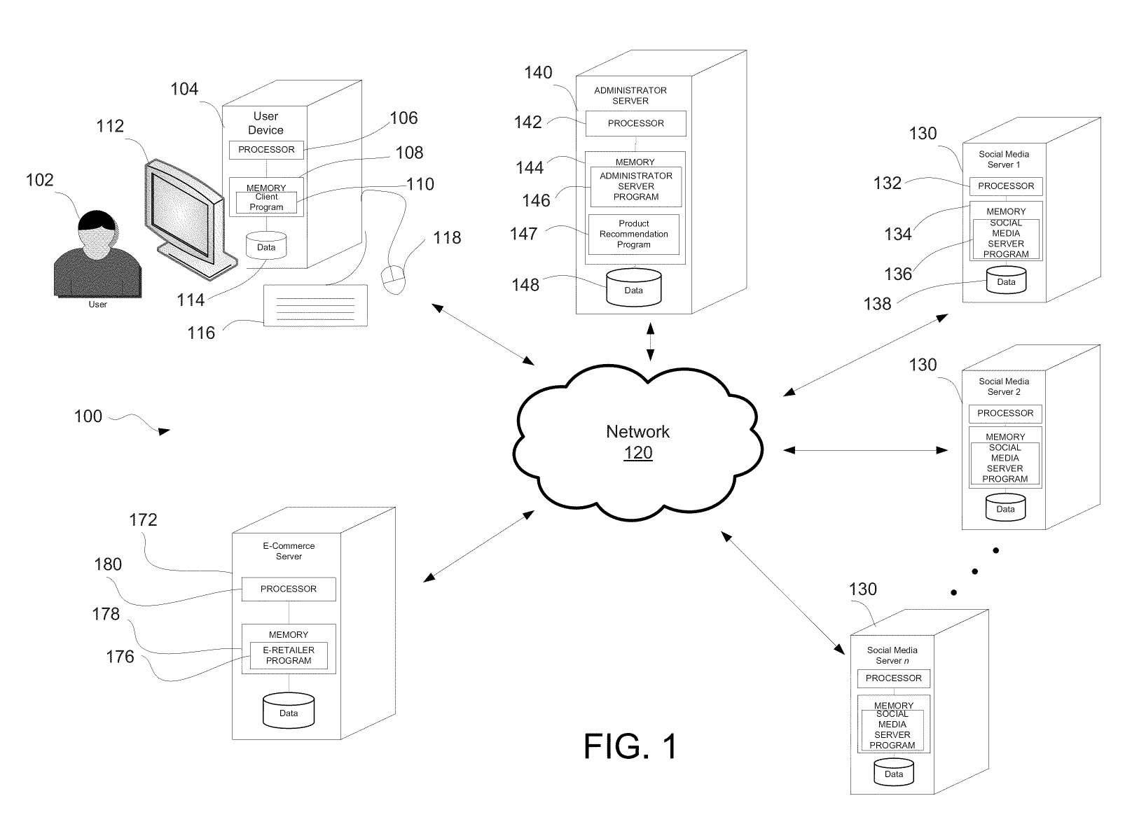

Referring now to FIG. 1, according to examples of embodiments of the present invention, a system 100 can be utilized to generate one or more social media tickers to a user 102 and to display advertisements to the user 102. In particular, the system 100 may include a user device 104 having a processor 106 and a memory 108. As understood by those skilled in the art, the memory 108 of the user device 104 can include volatile and nonvolatile memory including, for example, RAM, ROM, and magnetic or optical disks, just to name a few.

Stored in the memory 108 may be a client program 110, the purpose and functionality of which will be described in more detail hereinafter. As further understood by those skilled in the art, the client program 110 can be in the form of microcode, programs, routines, and symbolic languages that provides a specific set of ordered operations that control the functioning of the hardware, e.g., the processor 106, and direct its operation, as known and understood by those skilled in the art. The client program 110, according to an embodiment of the present invention, need not reside in its entirety in volatile memory, but can be selectively loaded, as necessary, according to various methodologies as known and understood by those skilled in the art.

The user device 104 also includes a display 112 as known and understood by those skilled in the art. In an embodiment, the display 112 is a touchscreen display or any other type of display. The user device 104 may include an electronic storage medium 114 for storing data. The electronic storage medium 114 may be a hard drive, for example.

The user device 104 itself may take a wide variety of forms. In an illustrative embodiment, the user device 104 is a desktop computer. In another illustrative embodiment, the user device 104 is a laptop computer. In another illustrative embodiment, the user device 104 is a handheld computing device. In another illustrative embodiment, the user device 104 is a smart phone. In another illustrative embodiment, the user device 104 is a gaming console, a Blu-ray player, DVD player, or a media streaming device connected to a television. In another illustrative embodiment, the user device 104 is a smart television. In another illustrative embodiment, the user device 104 includes a portable and handheld digital music player.

In another illustrative embodiment, the user device 104 includes a user input device. For example, the input device may include a keyboard 116 and a computer mouse 118 as shown in FIG. 1. In another illustrative embodiment, the user input device includes a touchscreen on the display 112. In another illustrative embodiment, the user input device may include a game controller. In another illustrative embodiment, the user input device may include a remote control. Thus, it will be appreciated that the user device 104 can by any type of electronic device that has a display and that accepts user input through a wide variety of user input devices.

As is known to one having ordinary skill, the processor 106 of the user device 104 may execute an operating system stored in the memory 108 (not explicitly shown). For example, the operating system may be any of the WINDOWS operating systems developed by Microsoft, Inc., the ANDROID operating system developed by the Open Handset Alliance and Google, Inc., the iOS operating system developed by Apple Inc., the OS X operating system developed by Apple, Inc., or any other operating system.

The user device 104 may be connected to a network 120. It will be appreciated that the network 120 may comprise a collection of hardware components, software components, and computers interconnected by communication channels that allow sharing of resources and information between electronic devices. The network 120 may include several independent networks, including wired and wireless networks. In another illustrative embodiment, the network 120 may include the Internet.

Using the user device 104, the user 102 is able to establish a user account with one or more social media websites hosted by social media servers 130. Exemplary social media websites include FACEBOOK, GOOGLE+, MYSPACE, LINKEDIN, FOURSQUARE, TWITTER, and others. In addition, social media websites may include blogs, or any other websites that allow users to post and share information. In addition, as used herein, the term “social media websites” may include news websites or any other websites hosted by a server that provide information, including websites that provide RSS (Really Simple Syndication) feeds.

Each of the social media servers 130 may be connected to the user device 104 over the network 120. Each of the social media servers 130 may include a processor 132 and a memory 134. Stored in the memory 134 may be a social media server program 136 to run the social media website. Each of the social media servers 130 may include an electronic storage medium 138 for storing user data.

The social media servers 130 may provide an online service, platform, or enterprise that allows users to build social networks or social relations among people who, for example, share interests, activities, backgrounds, or real-life connections. Typically, to establish a user account, each user provides a unique login and password for each of the social media websites hosted by the social media servers 130. In addition, each of the users may provide profile information to the social media servers 130, such as age, life events, location, interests, and hobbies.

Once enrolled with a social media website, a user may form contacts with other users of the social media website hosted by a social media server 130. For example, a user may invite acquaintances to become “friends” or “followers,” referred to generally herein as “contacts.” Over time, a user may build a large list of contacts that are stored in conjunction with the user's profile at the respective social media servers 130. A user may grant other contacts permission to view his or her profile information. Typically, permission to view a particular user's profile is only granted to individuals that are on that user's contact list.

In addition, the social media servers 130 may allow users to post information and upload information, commonly referred to as “entries” or “posts,” from remote electronic devices, such as the user device 104. In this regard, a user profile may also have a comment or wall section dedicated to showing posts from the user and from the user's contacts. That is, posts made by a user are posted in the user profiles of that user's contacts such that the user's contacts may view the posts provided by the user.

Likewise, posts made by the user's contacts are also posted in a comment or wall section of the user's profile. Thus, a user's profile may contain a running list of posts made by the user and the user's contacts. Further, the social media servers 130 may allow users to post comments on posts made by other users. In addition, the social media servers 130 may allow users to indicate an agreement or disagreement with posts made by other users. For example, a user may be able to “like” or “dislike” a post posted by another user. It will be understood, that as used herein, the term “social media content” includes posts made by users and the users' contacts.

In addition, the social media servers 130 may automatically generate posts. For example, the social media servers 130 may generate a post based on a user's profile information. This may include the social media servers 130 automatically generating a post regarding a life event listed in a user profile, such as a birthday, anniversary, or wedding. The automatically generated post may inform the user's contacts of the life event. It will be understood, that as used herein, the term “social media content” includes posts automatically generated by a social media server.

Once the user 102 has enrolled with one or more of the social media servers 130 in the manner explained above, the client program 110 may be installed in the memory 108 of the user device 104. In an embodiment, the client program 110 may be downloaded from an administrator server 140 over the network 120. In an embodiment, the client program 110 may be pre-loaded on the user device 104 or uploaded from a portable electronic storage medium, such as a USB drive. As will be explained in more detail below, the client program 110, when executed by the processor 106, is operable to generate one or more social media tickers on the display 112 of the user device 104 based upon a data feed received from the administrator server 140.

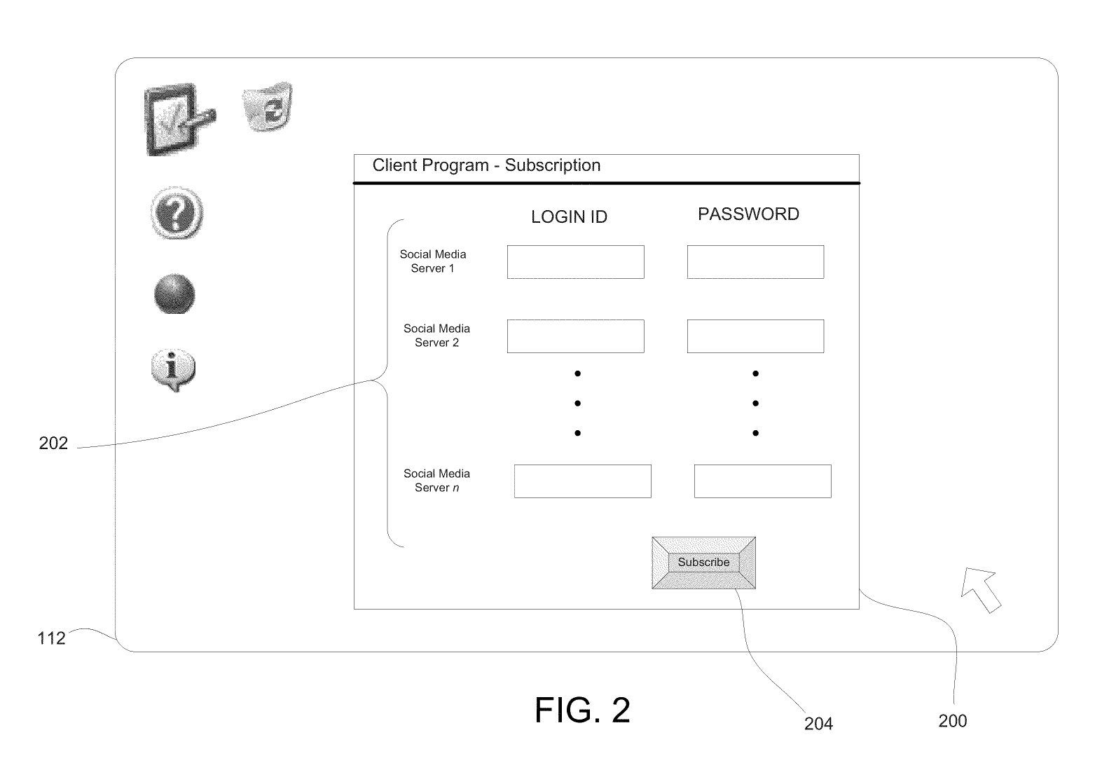

Referring now to FIG. 2, to provide one or more social media tickers on the display 112 of the user device 104 pursuant to the present invention, the client program 110 first prompts the user 102 through a window 200 on the display 112 of the user device 104 to select from a list 202 of pre-determined social media websites. In particular, the client program 110 may prompt the user to subscribe by entering account information, such as a login ID and password, for each of the social media websites for which the user 102 desires ticker updates of social media content pursuant to the present invention. Because each social media website is hosted on a different one of the social media servers 130, a separate login ID and password are required for each one.

Once the required login ID and password have been entered, then the user 102 may select the button 204 labeled “Subscribe.” Upon selection of the button 204 by the user 102, the login IDs and passwords for the selected social media websites are transmitted to the administrator server 140. The administrator server 140 then uses the login IDs and passwords to access the user accounts of the user 102 on the social media websites hosted by the servers 130. In particular, if the login IDs and passwords are valid, then each of the social media servers 130 will authorize the administrator server 140 to access the respective user accounts of the user 102.

The authorization granted by the social media servers 130 will allow the administrator server 140 to request and receive information regarding the user's user accounts on the social media servers 130. In an illustrative embodiment, the authorization may allow the administrator server 140 to receive posts made to the user profile of the user. In addition, the authorization may allow the administrator server 140 to access the user profile information of the social media contacts of the user.

Prior to proceeding, the configuration of the administrator server 140 will now be explained in more detail. As understood by those skilled in the art and with reference to FIG. 1, the administrator server 140 may include a processor 142 and a memory 144. The memory 144 can include volatile and nonvolatile memory as known to those skilled in the art including, for example, RAM, ROM, and magnetic or optical disks, just to name a few. Thus, it should also be understood by those skilled in the art that although illustrated as a single server computer, the administrator server 140 is given by way of example and that other types of servers or computers configured according to various other methodologies known to those skilled in the art can be used. The administrator server 140, shown schematically in FIG. 1, represents a server or server cluster or server farm and is not limited to any individual physical server. The server site may be deployed as a server farm or server cluster managed by a server hosting provider. The number of servers and their architecture and configuration may be increased based on usage, demand, and capacity requirements for the system 100.

Stored in the memory 144 of the administrator server 140 may be an administrator server program 146. As further understood by those skilled in the art, the administrator server program 146 can be in the form of microcode, programs, routines, and symbolic languages that provide a specific set for sets of ordered operations, or instructions, that control the functioning of the hardware, e.g., the processor 142, and direct its operation, as known and understood by those skilled in the art. The administrator server program 146, according to an embodiment of the present invention, also need not reside in its entirety in volatile memory, but can be selectively loaded, as necessary, according to various methodologies as known and understood by those skilled in the art.

The administrator server program 146 can be copied from a computer-readable medium to a hard disk or a similar intermediate storage medium when the administrator server program 146, or portions thereof, are to be run, it can be loaded either from their distribution medium or their intermediate storage medium into the execution memory of the administrator server 140, configuring the server 140 to act in accordance with the functionality or method of various embodiments of this invention. All such operations are well known to those skilled in the art of computer systems.

When running the administrator server program 146, the administrator server 140 is able to act to carry out the features and functionality of the present invention. In particular, the administrator server 140 is able to communicate with the user device 104 over the network 120. The administrator server 140 enrolls the user device 102 and stores the enrollment information in an electronic storage medium 148 of the administrator server 140.

After the user 102 provides the login IDs and passwords at the user device 104 as explained above in relation to FIG. 2, the social media servers 130 authorize the administrator server 140 to access the user accounts of the user 102 on the social media websites hosted by the social media servers 130. The administrator server 140 may utilize an API to access the social media websites hosted by the social media servers 130. For example, the FACEBOOK API is a platform for building applications that are available to the members of the social network of FACEBOOK. The FACEBOOK API allows third-party applications to use the social connections and profile information to make applications more involving, and to publish activities to the news feed and profile pages of FACEBOOK, subject to individual users privacy settings.

In an illustrative embodiment, the social media servers 130 may provide data feeds to the administrator server 140 containing the social media content posted to the user profile of the user 102. The requests for the data feeds from the social media servers 130 are made by the administrator server 140 using the appropriate API request.

Each time that the user profile of the user 102 is updated with new social media content, such as a post to a wall or comment section, then the administrator server 140 receives a data feed from the social media server 130 containing the new social media content. For example, if the new social media content is a post, then the new social media content may comprise the name of the person who made the post, the profile picture of that person, and the contents of the post, which may include text, a link, or a photograph. In addition, the administrator server 140 is able to request and receive user profile information of the person who made the post from the social media server 130. In addition, the administrator server 140 requests and receives profile information of the social media contacts of the user 102 from the social media servers 130 subject to the permissions granted by the contacts. As will be explained in more detail hereinafter, the user profile information of the contacts of the user 102 allows the administrator server 140 to recognize life events that traditionally invoke gift giving and to make gift recommendations for the life event based upon the contacts' interests and hobbies.

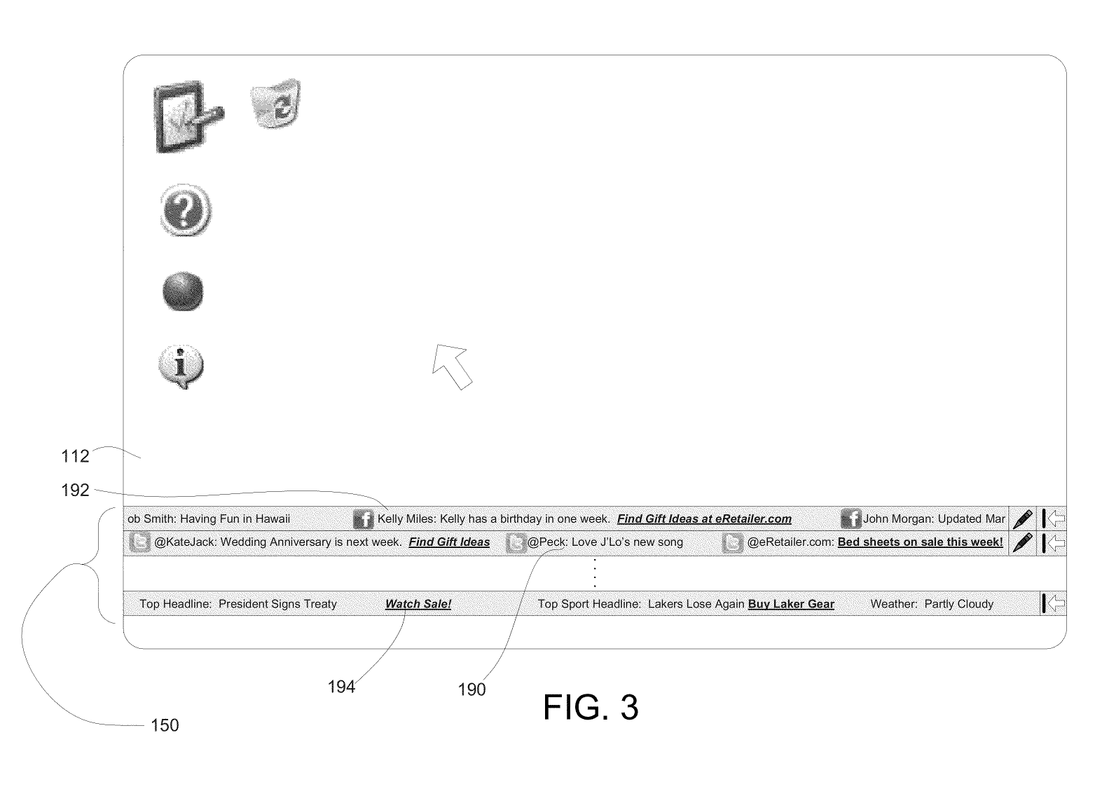

Referring now to FIG. 3, the administrator server 140 may provide data feeds to the user device 104 containing the social media content received from the social media servers 130. To display the social media content to the user 102, the client program 110 may generate one or more ticker bars 150 on the display 112 of the user device 104. Each of the ticker bars 150 may correspond to one of the social media servers 130. In an embodiment, social media content received from multiple social media servers 130 may be aggregated and displayed in a single ticker bar 150.

The client program 110 at the user device 104 may queue the social media content. The social media content may be scrolled across the ticker bars 150 on a first in first out basis. As shown in FIG. 3, the social media content in the ticker bars 150 is shown scrolling from right to left across the display 112. Further, the client program 110 may allow the user 102 to locate the ticker bars 150 at any desirable location on the display 112. For example, the client program 110 may allow the user 102 to click and drag the ticker bars 150 to any desired location on the display 112. The client program 110 may allow the user 102 to pause, hide, quit, collapse, rearrange, expand, or move any of the ticker bars 150. If hidden, collapsed or paused, the client program 110 may store incoming data feeds from the administrator server 140 in the queue until the social media content can be shown on the ticker bars 150.

The social media content displayed in the ticker bars 150 may comprise posts made by the user 102 and posts made by the contacts of the user 102 on the social media websites. These posts would typically appear on in the comment section or wall of the user profile of the user 102 if the user 102 were directly logged into the social media servers 130. An example of a post from a contact of the user 102 is shown by the reference arrow 190.

In addition, the ticker bars 150 may display posts containing the advertisement generated by the administrator server 140. For example, if the administrator server 140 receives user profile information of a contact of the user 102 that indicates that a life event of the contact will occur in the near future, the administrator server 140 will generate an advertisement in the form of a post inviting the user 102 to purchase a gift for the life event. An example of such an advertisement is shown by the reference arrow 192 in FIG. 3.

Another type of post displayed by the ticker bars 150 may be advertisements from e-commerce websites. These advertisements may be generated and posted to the ticker bars 150 by the administrator server 140. An example of such an advertisement is shown by the reference arrow 194.

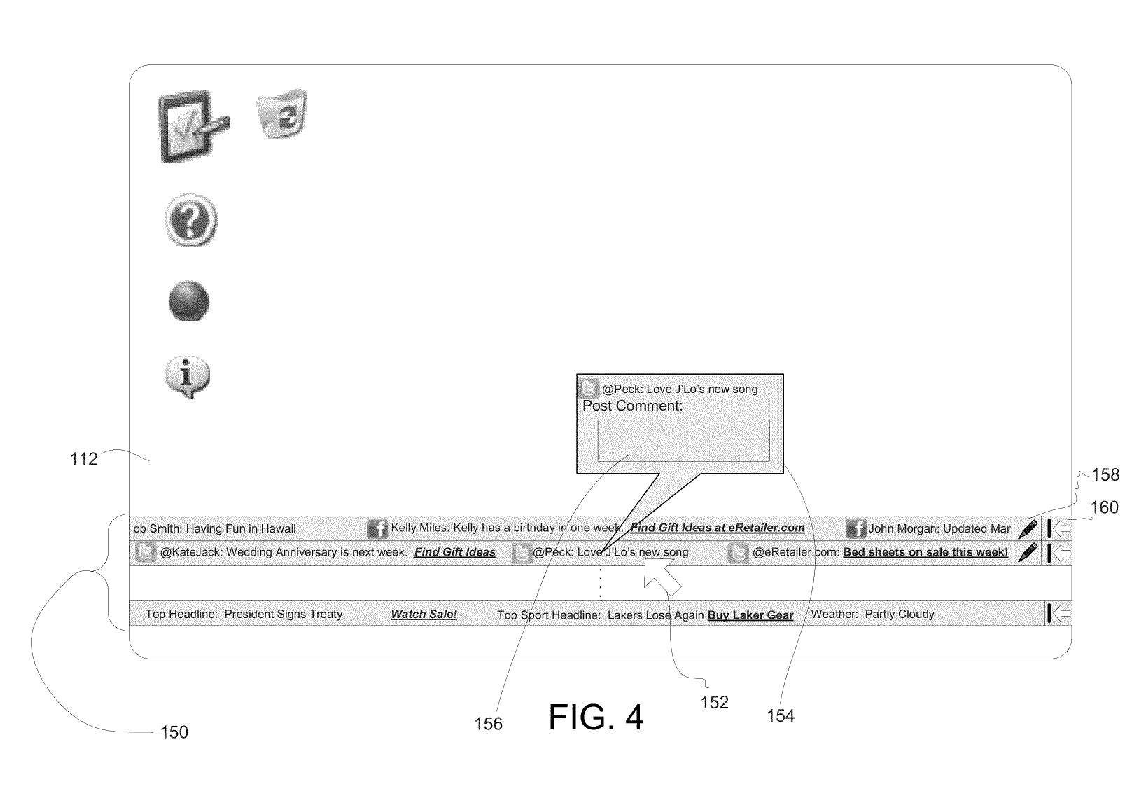

Referring now to FIG. 4, when the user 102 moves a pointer 152 on the display 112 over one of the ticker bars 150, the client program 110 will pause the scrolling of the feed on the ticker bar 150. The user 102 may also rewind the feed on a ticker bar 150 by clicking and dragging it to the right (the opposite direction of the feed). The user 102 may then move the pointer 152 over a desired post. When the pointer 152 is paused over a post in a ticker bar 150, then the client program 110 may generate a pop-up window 154. The pop-up window 154 may include a text entry box 156 that allows a user to post a comment on the relevant social media website in response to the post. In addition, a first icon 158 may allow the user 102 to post a new entry, with text and photographs, to the user profile of the user 102 on the social media website. A second icon 160 may allow the user 102 to hide a ticker bar 150.

Referring now back to FIG. 1, as discussed above, the administrator server 140 receives social media content from the social media servers 130. The social media content may include user profile information of the contacts of the user 102 on the social media servers 130. Using the social media content, the administrator server 140 may generate posts with advertisements that are transmitted to, and displayed by, the client program 110 in the ticker bars 150.

For example, the social media content may include information regarding an upcoming birthday of one of the contacts of the user 102. Upon recognition of the upcoming event, the administrator server 140 generates and inserts an advertisement in the form of a post into the data feed to the client program 110 running on the user device 104. The client program 110 will then display the post to the user 102 in the appropriate one of the ticker bars 150.

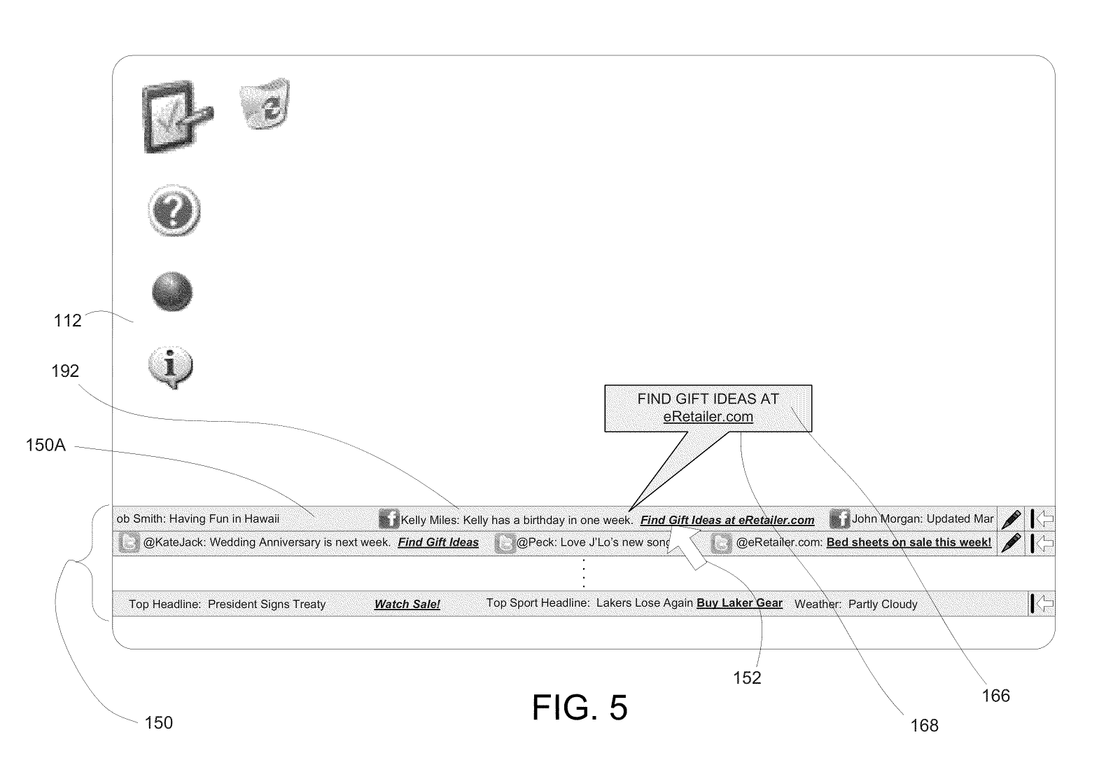

As shown in FIG. 5, the ticker bar 150A may include a post 192 that contains a notification of an upcoming birthday of one of the contacts of the user 102. The post 192 may include an advertisement inviting the user 102 to find a gift. It will be appreciated that the advertisement may be text, a picture, icon or some other graphical indicator that invites the user 102 to investigate recommended gift ideas associated with the life event of the contact. When the user 102 moves the pointer 152 over the advertisement in the post 192, a pop-up window 166 may be generated that invites the user 102 to take further action. For example, the pop-up window 166 may include a link 168 to a product recommendation page associated with an e-commerce website. The user 102 is prompted to click on the link 168.

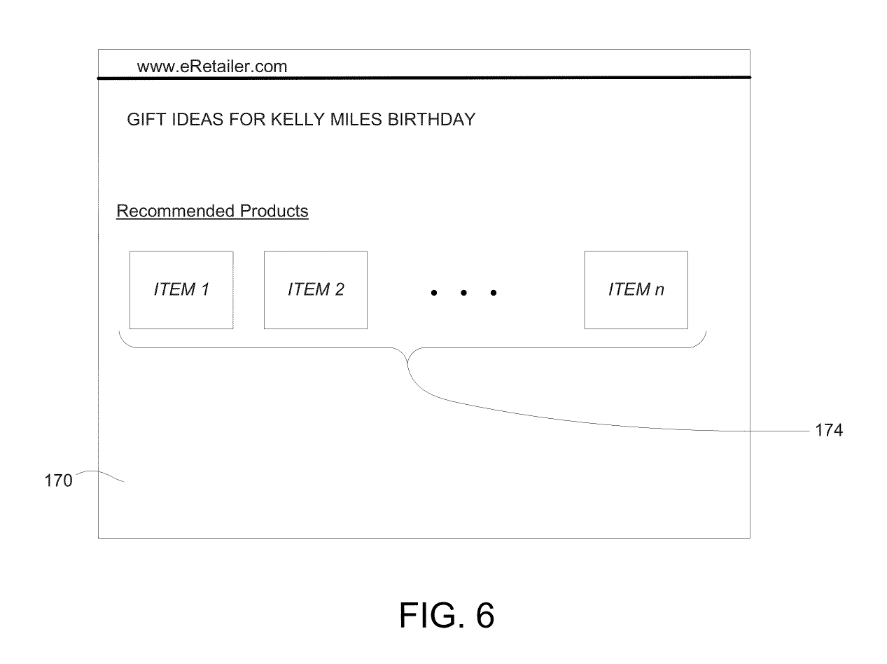

When the user 102 clicks on the link 168, the client program 110 may launch a web browser on the user device 104. The link 168 may direct the web browser to a product recommendation page 170 (see FIG. 6) of an e-commerce website associated with an e-commerce server 172 (see FIG. 1).

Referring to FIG. 6, the product recommendation page 170 may include offers for specific products 174 that are specifically recommended for the contact having the life event. The user 102 can then proceed to make a purchase for one of the products 174 from the e-commerce server 172 as is known to those having skilled in the art using the user device 104.

The manner in which the product recommendations are made for the contact will now be explained in more detail pursuant to an embodiment of the present disclosure with reference to FIG. 1. As mentioned above, the administrator server 140 may have access to user profile information of the social media contacts of the user 102 on the social media servers 130. The user profile information of a contact may provide information upon which a product recommendation can be generated. For example, the user profile information of a contact may indicate the gender of the contact, the interests and hobbies of the contact, the likes and dislikes of the contact, the profession of the contact, the life events of the content, places of interest to the contact, the relationship status of the contact, the age of the contact, the education of the contact, and the religious views of the contact.

The memory 144 of the administrator server 140 may include a product recommendation program 147 (FIG. 1). The product recommendation program 147, when executed, may generate product recommendations for a contact of the user 102 based on the contact's user profile information on a social media website. For example, if the user profile information of the contact indicates that the contact enjoys hiking, then the product recommendation program 147 may identify and recommend hiking related products as gifts for the contact that may be purchased by the user 102.

Prior to the generation of the product recommendation page 170 shown in FIG. 6, the administrator server 140 may provide the product recommendations generated by the product recommendation program 147 to the e-commerce server 172 over the network 120. The e-commerce server 172 may utilize the product recommendations generated by the product recommendation program 147 to generate the product recommendation page 170. In an embodiment, the e-commerce server 172 may further refine the product recommendations generated by the product recommendation program 147 based on the availability of products or other factors.

For example, the product recommendation program 147 may generate a category of products that the contact might enjoy based on the user profile of the contact. The e-commerce server 172 may include an e-retailer program 176 in a memory 178 connected to a processor 180 (FIG. 1). The e-retailer program 176 may generate specific product recommendations based on the category of products generated by the product recommendation program 147.

In an illustrative embodiment of the present disclosure, the product recommendation program 147 may reside on the e-commerce server 172. In this embodiment, the administrator server 140 may send the necessary user profile information of the contact to the e-commerce server 172 such that the e-commerce server 172 can directly generate product recommendations for the contact. In an embodiment, the product recommendation program 147 may reside on a server that is not directly associated with either the e-commerce server 172 or the administrator server 140.

In an illustrative embodiment of the present disclosure, the product recommendation program 147 may generate a list of recommended products for the user 102 based on the user profile of the user 102 on the social media servers 130. In addition, as used herein, the term “product” may refer to a product, service, ticket, gift card, voucher, coupon, or any other item, service or thing that may be given as a gift.

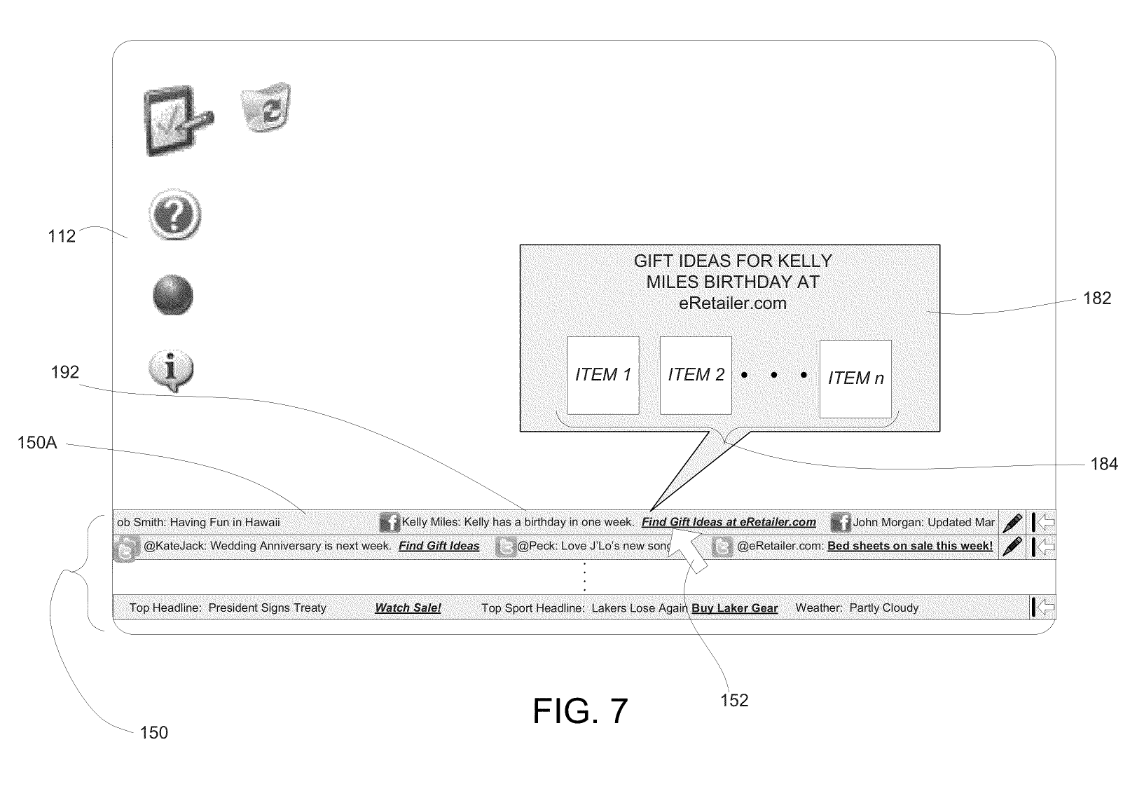

Referring now to FIG. 7, in an illustrative embodiment of the present invention, when the user 102 moves the pointer 152 over the advertisement 192 in the ticker bar 150A, the client program 110 may generate a pop-up window 182. The pop-up window 182 may include advertisements for a list of specific recommended products 184 for the contact. The offers may include photographs and price of the recommended products. The user 102 may purchase the desired one of the recommended products 184 by clicking on the advertisement. In particular, when one of the offers is selected by the user 102, the client program 110 will launch a web browser on the user device 104, which will then load a product page or a checkout page generated by the e-commerce server 172. The user 102 may then purchase the product for the contact as a gift.

In an illustrative embodiment of the present disclosure, the administrator server 140 may generate advertisements and links for the user 102 based on the profile information of the user 102 provided to the social media servers 130. As seen in FIG. 3, a post, such as post 194 with an advertisement may be generated by the administrator server 140 and provided to the client program 110 such that it is displayed in one of the ticker bars 150.

It will be appreciated that the number of ticker bars 150 generated by the client program 110 may vary. For example, the client program 110 may generate a single ticker bar, or any number of ticker bars depending on the needs of the user 102. The only limitation on the number of ticker bars generated by the client program 110 is that the administrator server 140 needs to have implemented the appropriate API in order to communicate with all of the desired social media servers, since each social media server may require a unique API.

As previously mentioned, the social media servers 130 may include servers that provide RSS feeds. The RSS feeds may be included in the ticker bars 150 by the client program 110. For example, the ticker bars 150 may include a ticker bar that is a dedicated news feed for a website. In an embodiment, the news feed allows users to see new content published on websites. For example, a news feed may include the latest headlines and video as soon as it is published on a website. Links in the news feed refer users back the original news source.

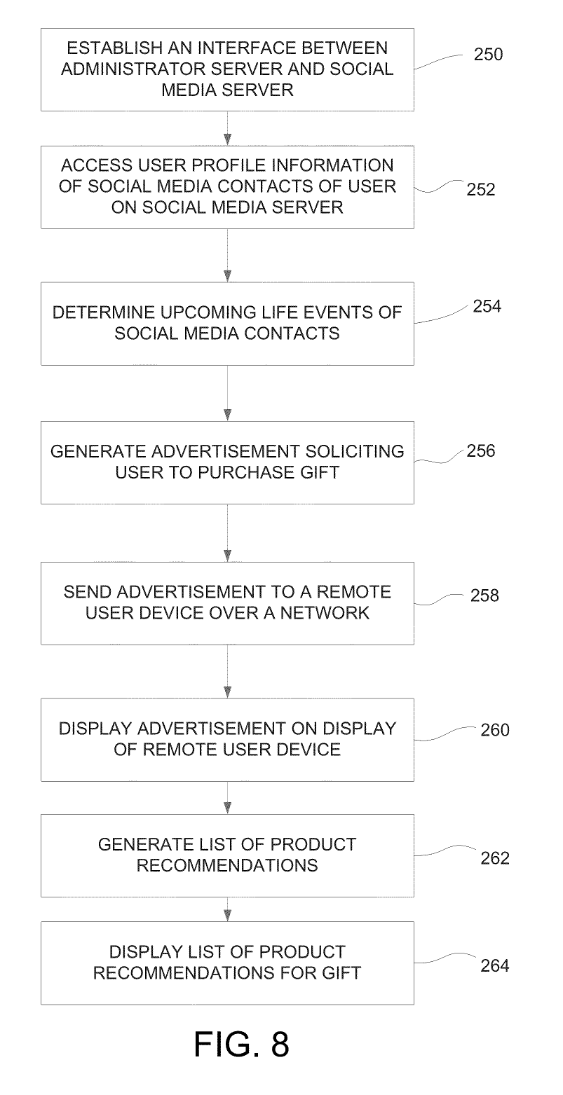

Referring now to FIG. 8, according to an illustrative embodiment of the present invention, a method, for example, can include the following steps. At step 250, the method includes establishing an interface between a remote administrator server and a social media server of a social media website. The interface is established over a network, such as the Internet. The interface may be established using an API. At step 252, the administrator server accesses the social media account of a user on the social media server. This may require prompting the user to provide the user's login ID and password for the social media website. The administrator server may prompt the user to provide this information on a remote user device over the network.

At step 254, the administrator server requests and receives user profile information of the user's social media contacts on the social media website's server. The user profile information may include information relating to the life events of the user's social media contacts. The administrator server will then determine if any of the user's social media contacts has an upcoming life event, such as a birthday.

At step 256, the administrator server generates an advertisement related to the upcoming life event of one of the user's social media contacts. The advertisement includes a solicitation that invites the user to purchase a gift for the social media contact having the upcoming life event. The advertisement may include a link to a product recommendation page of an e-commerce server.

At step 258, the administrator server provides the advertisement to a remote user device associated with the user. In an illustrative embodiment, the administrator server streams the advertisement over a network to the user device along with other social media content posted on the social media server. In an illustrative embodiment, the administrator server sends the advertisement in an email to an email account associated with the user. At step 260, the method includes displaying the advertisement to the user on the user device. In an illustrative embodiment, the advertisement is displayed in an interactive ticker bar along with social media content posted to the user's account on the social media website.

At step 262, the method includes generating a list of product recommendations for the social media contact having the life event based on the user profile of that social media contact obtained from the social media server by the administrator server. At step 264, the method includes displaying a list of product recommendations to the user on the user device in response to user interaction with the advertisement. In an illustrative embodiment, the method includes opening a product recommendation page on an e-commerce website hosted by an e-commerce server using a web browser. The user is able to complete an e-commerce transaction for one of the recommended products.

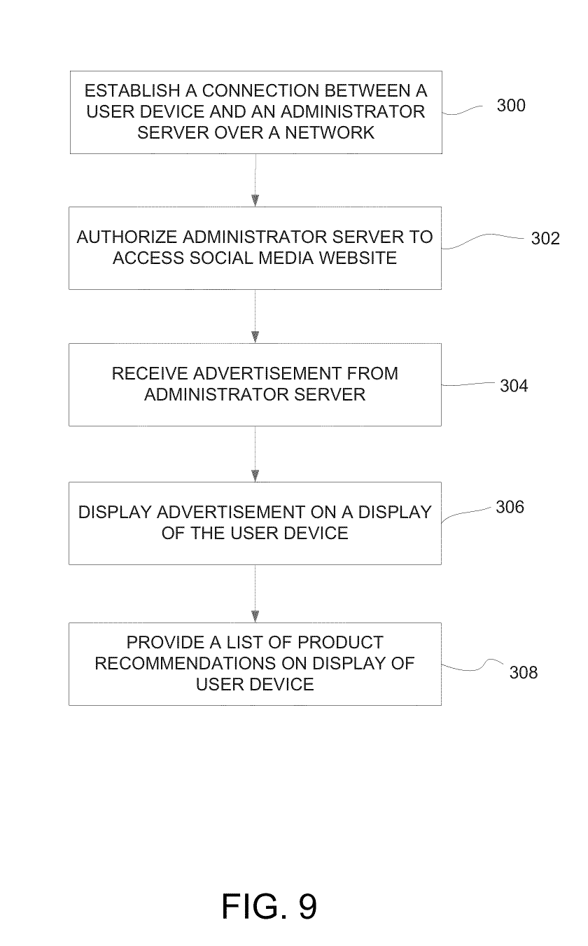

Referring now to FIG. 9, according to an illustrative embodiment of the present invention, a method, for example, can include the following steps. At step 300, the method includes establishing a connection over a network between a user device and an administrator server. In an illustrative embodiment, a client program running on the user device establishes the connection. At step 302, the user device prompts the user to authorize the administrator server to access a user account on a social media website. In this step, the user may provide user account information for a selected social media website. The user account information typically includes login ID and password information.

At step 304, the user device receives an advertisement from the administrator server. In an illustrative embodiment, the advertisement is streamed to the user device. The advertisement contains a solicitation to purchase a gift for one of the user's social media contacts on the social media website based on an upcoming life event of the social media contact. At step 306, the advertisement is displayed on the display of the user device. In an illustrative embodiment, the advertisement is displayed in a ticker bar display. That is, the advertisement scrolls across the display of the user device in a ticker bar. The advertisement is interactive. In an illustrative embodiment, the advertisement contains a link to a product recommendation page of an e-commerce website.

At step 308, the user interacts with the advertisement. For example, the user may click on a link contained within the advertisement. In response, the user device provides a display of product recommendations on the display of the user device. In an illustrative embodiment, the user device opens a web browser to display a product recommendation page generated by an e-commerce website hosted by an e-commerce server. The user can then purchase one of the recommended products.

It is important to note that while various embodiments of the present invention have been described in the context of a fully functional system, those skilled in the art will appreciate that the mechanism of a last portion of the present invention and/or aspects thereof are capable of being distributed in the form of a computer readable medium of instructions in a variety of forms for execution on a processor, processors, or the like, and that embodiments of the present invention apply equally regardless of the particular type of signal bearing media used to actually carry out the distribution. Examples of computer readable media include but are not limited to: nontransitory, nonvolatile, hard-coded type media such as read only memories (ROMs), CD-ROMs, and DVD-ROMs, or erasable, electrically programmable read only memories (EEPROMs), recordable type media such as floppy disks, hard disk drives, CD-R/RWs, DVD-RAMS, DVD-R/RWs, DVD+R/RWs, flash drives, and other newer types of memories, and transmission type media such as digital and analog communication links. For example, such media can include both operating instructions and operations instructions related to the various program product and the method steps, described above.

Throughout this specification and as understood by those skilled in the art, the term “link” is defined as a reference to an online location, a pointer, a hypertext link, a hyperlink, or navigation element within a website to another section of the same website or to another website. Often, a link is embedded within text that is colored and underlined. Other links are embedded within icons or graphics. Typically, links are recognized by moving a cursor over the icon and having the cursor change visually, for example, from an arrow to a pointing finger, as understood by those skilled in the art. Link information can generally be accessed by, for example, right-clicking on the text or icon and selecting properties; alternately, hovering over a link may case information to pop up and be displayed over the icon, text, or graphic, as understood by those skilled in the art. In addition, the term “rerouting” or “linking” means directing, redirecting, or transporting the viewer from one a section of one website to another section of the same website or to another website, typically as a result of clicking on a link, as understood by those skilled in the art. Further, the terms “item for sale” and “product” refer to goods, services, and goods and services.

In the drawings and specification, there have been disclosed a typical preferred embodiment of the invention, and although specific terms are employed, the terms are used in a descriptive sense only and not for purposes of limitation. The invention has been described in considerable detail with specific reference to these illustrated embodiments. It will be apparent, however, that various modifications and changes can be made within the spirit and scope of the invention as described in the foregoing specification.

In the foregoing Detailed Description, various features of the present disclosure are grouped together in a single embodiment for the purpose of streamlining the disclosure. This method of disclosure is not to be interpreted as reflecting an intention that the claimed disclosure requires more features than are expressly recited in each claim. Rather, as the following claims reflect, inventive aspects lie in less than all features of a single foregoing disclosed embodiment. Thus, the following claims are hereby incorporated into this Detailed Description of the Disclosure by this reference, with each claim standing on its own as a separate embodiment of the present disclosure.

It is to be understood that the above-described arrangements are only illustrative of the application of the principles of the present disclosure. Numerous modifications and alternative arrangements may be devised by those skilled in the art without departing from the spirit and scope of the present disclosure and the appended claims are intended to cover such modifications and arrangements. Thus, while the present disclosure has been shown in the drawings and described above with particularity and detail, it will be apparent to those of ordinary skill in the art that numerous modifications, including, but not limited to, variations in size, materials, shape, form, function and manner of operation, assembly, and use may be made without departing from the principles and concepts set forth herein.

What is claimed is:

1. A method of aggregating social media content posted on social media websites, the method comprising:
receiving at a user device social media content from an administrator server, the social media content comprising social media content posted on a first social media server;
forming a first ticker bar on a display of the user device using a processor of the user device; and
scrolling the social media content posted on the first social media server in the first ticker bar across the display of the user device using the processor of the user device.

2. The method of claim 1, wherein the social media content received at the user device from the administrator server further comprises social media content posted on a second social media server, and the method further comprises:
forming a second ticker bar on the display of the user device using a processor of the user device; and
scrolling the social media content posted on the second social media server in the second ticker bar across the display of the user device using the processor of the user device.

3. The method of claim 2, wherein the social media content received at the user device from the administrator server further comprises social media content posted on a third social media server, and the method further comprises:
forming a third ticker bar on the display of the user device using a processor of the user device; and
scrolling the social media content from the third social media server in the third ticker bar across the display of the user device using the processor of the user device.

4. The method of claim 1, further comprising:
generating an interactive advertisement using the administrator server that solicits a user to purchase a product;
sending the advertisement from the administrator server to the user device; and
scrolling the interactive advertisement with the social media content in the first ticker bar across the display of the user device using the processor of the user device.

5. The method of claim 4, further comprising:
opening a link to a product page in a web browser in response to user interaction with the interactive advertisement as it scrolls across the display of the user device in the first ticker bar; and
consummating an e-commerce transaction for the product.

6. A method of providing advertisements to a user of a social media website hosted by a social media server, the method comprising:
establishing an interface over a network between an administrator server and a social media server based on user profile information provided by the user;
accessing user profile information of social media contacts of the user on the social media website using the administrator server;
determining an upcoming life event of one of the social media contacts of the user based on the user profile information of that social media contact using the administrator server;
generating an advertisement using the administrator server that solicits the user to purchase a gift for the one of the social media contacts in response to the upcoming life event; and
sending the advertisement from the administrator server to a user device associated with the user such that the advertisement is displayed to the user on a display of the user device.

7. The method of claim 6, further comprising scrolling the advertisement across the display of the user device on a ticker bar.

8. The method of claim 7, further comprising sending social media content posted on the social media website from the administrator server to the user device such that the social media content is scrolled across the display of the user device on the ticker bar.

9. The method of claim 8, wherein the social media content comprises posts made by the social media contacts of the user on the social media website.

10. The method of claim 6, further comprising displaying product recommendations to the user on the user device in response to user interaction with the advertisement, the product recommendations comprising a list of recommended products for the one of the social media contacts, wherein the list of recommended products is determined based on the user profile of the one of the social media contacts on the social media website.

11. The method of claim 10, further comprising providing a link to a product recommendation page in association with the advertisement, the product recommendation page containing the product recommendations.

12. The method of claim 11, wherein the product recommendation page is generated by an e-commerce server hosting an e-commerce website.

13. The method of claim 10, further comprising generating the list of recommended products at the administrator server.

14. The method of claim 6, wherein the life event is of a birthday, an anniversary, or a wedding.

15. A system for providing advertisements to a user of a social media website hosted by a social media server, the system comprising:
an administrator server having a processor and a memory coupled to the processor;
the memory having stored therein a set of computer readable instructions that, when executed, cause the processor to perform the operations of:
establishing an interface over a network between the administrator server and the social media server based on user account information provided by the user,
accessing user profile information of social media contacts of the user on the social media website,
determining an upcoming life event of one of the social media contacts of the user based on the user profile information of that social media contact,
generating an advertisement that solicits the user to purchase a gift for the one of the social media contacts in response to the upcoming life event, and
sending the advertisement to a user device associated with the user such that the advertisement is displayed to the user on a display of the user device.

16. The system of claim 15, wherein the advertisement is scrolled across the display of the user device on a ticker bar.

17. The system of claim 15, wherein the set of computer readable instructions is further operable to cause the processor to perform the operations of:
sending social media content posted on the social media website from the administrator server to the user device such that the social media content is scrolled across the display of the user device on a ticker bar.

18. The system of claim 17, wherein the social media content comprises posts made by the social media contacts of the user on the social media website.

19. The system of claim 15, wherein the set of computer readable instructions is further operable to cause the processor to perform the operations of:
generating a list of recommended products for the one of the social media contacts based on the user profile of the one of the social media contacts on the social media website; and
sending the list of recommended products to the user device such that the list of recommended products is displayed to the user.

20. The system of claim 15, wherein the set of computer readable instructions is further operable to cause the processor to perform the operations of:
providing a link to a product recommendation page in association with the advertisement to the user device.

21. A computer program stored on a non-transitory computer medium, the computer program including instructions that, when executed, cause a processor of an administrator server to perform the operations of:
establishing an interface over a network between the administrator server and a social media server based on user account information provided by a user;
accessing user profile information of social media contacts of the user on the social media server;
determining an upcoming life event of one of the social media contacts of the user based on the user profile information of that social media contact;
generating an advertisement that solicits the user to purchase a gift for the one of the social media contacts in response to the upcoming life event;
sending the advertisement to a user device associated with the user such that the advertisement is displayed to the user on a display of the user device; and
sending social media content posted on the social media website from the administrator server to the user device such that the social media content is scrolled across the display of the user device on a ticker bar.

22. A method of providing advertisements to a user of a user device, the user having a user account with a social media website hosted by a social media server, the method comprising:
establishing a connection between the user device and an administrator server over a network;
authorizing the administrator server to access the social media website using user account information provided by the user;
receiving an advertisement from the administrator server over the network at the user device, the advertisement containing a solicitation to purchase a gift for a social media contact of the user on the social media website based on an upcoming life event of the social media contact;
displaying the advertisement on a display of the user device; and
providing a list of product recommendations for the gift on the display of the user device in response to the user interacting with the advertisement.

23. The method of claim 22, further comprising scrolling the advertisement across the display of the user device in a ticker bar.

24. The method of claim 22, wherein the advertisement comprises a link to a product recommendation page of an e-commerce website hosted by an e-commerce server.

25. The method of claim 24, further comprising opening a web browser on the user device to display the list of product recommendations on the product recommendation page.

26. The method of claim 22, further comprising receiving social media content from the administrator server over the network, the social media content posted by the social media contacts of the user on the social media website hosted by the social media server.

27. The method of claim 26, further comprising scrolling the advertisement and the social media content across the display of the user device in a ticker bar.

28. The method claim 27, further comprising repositioning the ticker bar on the display in response to user input.

29. The method of claim 27, further comprising pausing the display on the ticker bar in response to user input.

30. A user device for providing advertisements to a user, the user having a user account with a social media website hosted by a social media server, the user device comprising:
a display;
a processor and a memory coupled to the processor;
the memory having stored therein a set of computer readable instructions that, when executed, cause the processor to perform the operations of:
establishing a connection with administrator server over a network,
authorizing the administrator server to access the social media website using user account information of the user,
receiving an advertisement from the administrator server over the network, the advertisement containing a solicitation to purchase a gift for a social media contact of the user on the social media website based on an upcoming life event of the social media contact,
displaying the advertisement on the display, and
providing a list of product recommendations for the gift on the display in response to the user interacting with the advertisement.

31. The user device of claim 30, wherein the set of computer readable instructions, when executed, further cause the processor to perform the operation of scrolling the advertisement across the display in a ticker bar.

32. The user device of claim 30, wherein the advertisement comprises a link to a product recommendation page of an e-commerce website hosted by an e-commerce server.

33. The user device of claim 32, wherein the set of computer readable instructions, when executed, further cause the processor to perform the operations of opening a web browser and displaying the list of product recommendations on the product recommendation page in the web browser.

34. The user device of claim 30, wherein the set of computer readable instructions, when executed, further cause the processor to perform the operations of receiving social media content from the administrator server over the network, the social media content posted by the social media contacts of the user on the social media website hosted by the social media server.

35. The user device of claim 34, wherein the set of computer readable instructions, when executed, further cause the processor to perform the operations of scrolling the advertisement and the social media content across the display in an interactive ticker bar.
